(19) United States
(12) Patent Application Publication
(10) Pub. No.: US 2026/0259415 A1
(43) Pub. Date: Sep. 3, 2026

(54) OPTICAL MODULE AND HEAD-MOUNTED DISPLAY DEVICE

(71) Applicant: Goertek Optical Technology Co., Ltd., Shandong (CN)

(72) Inventor: Yudeng Wu, Shandong (CN)

(73) Assignee: Goertek Optical Technology Co., Ltd., Shandong (CN)

(21) Appl. No.: 18/995,785

(22) PCT Filed: Jul. 26, 2022
(86) PCT No.: PCT/CN2022/108012

§ 371 Date: Jan. 16, 2025

(51) Int. Cl. G02B 27/01; G02B 5/30

(52) U.S. Cl. CPC G02B 27/0172; G02B 5/3083

(57) ABSTRACT

The present disclosure provides an optical module and a head mounted display. The optical module includes: a lens group including at least one lens, a polarizing element, a beam splitting element, and a phase retarder, wherein the polarizing element, the beam splitting element, and the phase retarder are provided on either side of the at least one lens in the lens group; wherein a distance from a human eye to the polarizing element is A1; an eyebox of the human eye is EB, which satisfies: 0.5≤(EB/A1)≤1.

### CROSS-REFERENCE TO RELATED APPLICATIONS

The present disclosure is a National Stage of International Application No. PCT/CN2022/108012, filed on Jul. 26, 2022, which is hereby incorporated by reference in its entirety.

### TECHNICAL FIELD

Embodiments of the present disclosure relate to the technical field of near-eye display imaging, and particularly to an optical module and a head mounted display.

### BACKGROUND

In recent years, Augmented Reality (AR) and Virtual Reality (VR) technologies have found applications in devices such as a smart wearable device and have rapidly developed. Both AR and VR technologies rely on optical modules as their core components. The quality of image display produced by the optical modules directly determines the quality of a smart wearable device.

The imaging clarity of the VR device is a critical metric for assessing the VR experience, whereas the volume and weight of a VR device are key factors in evaluating aesthetics and wearing comfort thereof. Therefore, improving the imaging clarity of VR devices while minimizing its size is a pressing challenge that needs to be addressed.

### SUMMARY

An objective of the present disclosure is to provide new technical solutions for an optical module and a head mounted display.

According to a first aspect, the present disclosure provides an optical module, which includes:
a lens group including at least one lens;
wherein the optical module further includes a polarizing element, a beam splitting element, and a phase retarder; wherein the polarizing element, the beam splitting element, and the phase retarder are provided on either side of a lens in the lens group;
wherein a distance from a human eye to the polarizing element is A1;
an eyebox of the human eye is EB;
wherein the optical module satisfies: a ratio of the eyebox EB to the distance A1 from the human eye to the polarizing element is from 0.5 to 1.

Optionally, the optical module satisfies: 15 mm<F<35 mm, wherein F is an effective focal length of the optical module.

Optionally, the polarizing element has an effective diameter B1 of 44 mm to 63 mm.

Optionally, the optical module has an effective focal length F, wherein a ratio of the eyebox EB to the effective focal length F of the optical module is from 0.4 to 0.6.

Optionally, the optical module satisfies: 80°≤FOV≤120°.

Optionally, the lens group includes a lens proximate to a display screen side, and the beam splitting element is provided on one side of the lens facing away from the human eye.

Optionally, the lens group has a near-eye side, on which the polarizing element is provided; or
the lens group includes at least two lenses, with the polarizing element provided between two adjacent lenses.

Optionally, the phase retarder includes a first phase retarder, located between the beam splitting element and the polarizing element.

Optionally, the phase retarder further includes a second phase retarder;
the lens group includes a lens proximate to a display screen side, and the second phase retarder is provided on one side of the lens facing away from the human eye.

Optionally, the lens group includes a lens provided adjacent to the display screen, and the lens has a positive focal power.

Optionally, the eyebox EB is from 8 mm to 12 mm.

Optionally, the distance A1 from the human eye to the polarizing element is greater than 13 mm.

Optionally, the optical module further includes the display screen having a size of D1;
the polarizing element has an effective diameter B1;
a distance from the polarizing element to the display screen is L1;
wherein the optical module satisfies: −0.2< (B1/2−D1/2)/L1<0.8.

Optionally, a distance from the polarizing element to a display screen satisfies: 11 mm<L1<30 mm.

In a second aspect, a head mounted display is proposed. The head mounted display includes:
a housing; and
the optical module according to the first aspect.

According to the embodiment of the present disclosure, by controlling the ratio of the eyebox EB of the human eye to the distance from the human eye to the polarizing element, it is possible to realize that within the eyebox, when the user uses the optical module for visual viewing experience, the picture viewed appears clear and complete. This improves the imaging quality of the optical module.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 shows a first structural schematic diagram of an optical module provided in an embodiment of the present disclosure.

FIG. 2 shows a second structural schematic diagram of the optical module provided in an embodiment of the present disclosure.

FIG. 3 shows a third structural schematic diagram of the optical module provided in an embodiment of the present disclosure.

FIG. 4 shows a fourth structural schematic diagram of the optical module provided in an embodiment of the present disclosure.

### DESCRIPTION OF REFERENCE SIGNS

1. display screen; 2. lens group; 21. first lens; 22. second lens; 23. third lens; 3. polarizing element; 4. stop; 5. beam splitting element; 6. first phase retarder.

### DETAILED DESCRIPTION

Various exemplary embodiments of the present disclosure will now be described in detail with reference to the accompanying drawings. It is to be noted that unless otherwise specified, the relative arrangements, numerical expressions and values of components and steps illustrated in the embodiments do not limit the scope of the present disclosure.

The description of at least one exemplary embodiment is for illustrative purpose only and in no way implies any restriction on the present disclosure, its application, or use.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Therefore, other examples of the exemplary embodiments may have different values.

It is to be noted that similar reference numbers and alphabetical letters represent similar items in the accompanying drawings. Once an item is defined in one drawing, further reference to it may be omitted in subsequent drawings.

In the prior art, during the simulation and optimization process, it is assumed that the human eye is fixed within a preset area and is coaxially aligned with the optical axis of the optical module. Therefore, the relationship between the user's eyebox and the quality of the imaged picture has not been considered. In actual use, since the head wearable device is worn by different users, the eyes of different users may be in different positions, so that the quality of the imaged picture visually observed by different users is different; alternatively, due to some certain wearing reasons, the user's eyes may not be coaxially aligned with the optical axis of the optical module, such that the quality of the visually observed imaged picture is different from the quality of the image optimized by the simulation.

In view of the above technical problems, the first aspect of the embodiments of the present disclosure provides an optical module. The optical module is a folded optical path optical structure design, which may include at least one optical lens and be suitable for use in the head mounted display (HMD), such as VR headsets, which may include products like VR glasses or VR helmets, without any specific limitation in the embodiments of the present disclosure.

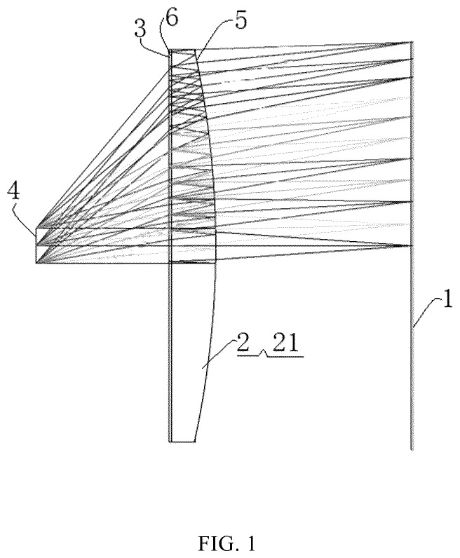

The optical module and the head mounted display provided by the embodiments of the present disclosure are described in detail below with reference to FIGS. 1 to 4.

The embodiments of the present disclosure provide an optical module. As shown in FIGS. 1 to 4, the optical module includes: a lens group 2 including at least one lens; the optical module further includes a polarizing element 3, a beam splitting element 5, and a phase retarder. Here, a distance from a human eye to the polarizing element 3 is A1; an eyebox of the human eye is EB; wherein the optical module satisfies: a ratio of the eyebox EB to the distance A1 from the human eye to the polarizing element 3 is from 0.5 to 1.

In other words, the optical module primarily comprises the lens group 2, the polarizing element 3, the beam splitting element 5, and the phase retarder.

The lens group 2 can include one lens or a plurality of lenses; the number of the lenses in the lens group 2 is not limited by the embodiments of the present disclosure. However, in the folded optical path, considering that light has already been folded, the number of lenses in the optical architecture of the folded optical path may be up to three compared with a direct optical architecture.

Here, to achieve the folded optical path design, the polarizing element 3, the beam splitting element 5, and the phase retarder are provided in the optical module. For example, the polarizing element 3, the beam splitting element 5, and the phase retarder are provided on either side of the lens group 2.

Specifically, for implementing the folded optical path design, the polarizing element 3, the beam splitting element 5, and the phase retarder are provided on any one side of the lens group 2. For example, the beam splitting element 5 is provided on the side of the lens group 2 facing towards the display screen 1; the polarizing element 3 is provided on the side of the lens group 2 facing away from the display screen 1, or on a side of one lens in the lens group 2; the phase retarder is provided on the side of the lens group 2 facing towards the display screen 1, or on a side of one lens in the lens group 2.

Here, the polarizing element 3 can be used to transmit P-polarized light and reflect S-polarized light; or the polarizing reflection element can be used to transmit S-polarized light and reflect P-polarized light. Specifically, the polarizing element 3 has a polarization transmission direction, and light can pass through the polarizing element 3 smoothly only when it vibrates along the polarization transmission direction, while light vibrating in other directions is reflected when it encounters the polarizing element 3. For example, the polarizing element 3 can be a polarizing reflection film, a reflective polarizer or the like. Regardless of where the polarizing element 3 is located, the present embodiment limits the distance L1 from the polarizing element 3 to the display screen 1 and the effective diameter B1 of the polarizing element 3.

Here, the phase retarder may be used to change the polarization state of light in the folded optical path structure, such as converting linearly polarized light into circularly polarized light or vice versa. For example, the phase retarder can be a quarter-wave plate.

Here, when the light passes through the beam splitting element 5, part of the light is transmitted and the other part is reflected, which does not consider the absorption of the light. For example, light propagating from the display screen 1 to the eye side may transmit through the beam splitting element 5, while light propagating from the eye side to the display screen 1 is reflected by the beam splitting element 5. The beam splitting element 5 may be a transflective film or a polarizing film.

Here, regardless of where the polarizing element 3 is provided within the lens group 2, the embodiment of the present disclosure only needs to limit the distance from the human eye to the polarizing element 3 as A1.

Here, the present embodiment limits the eyebox, that is, in the simulation and optimization process, the numerical value of the eyebox is limited. The eyebox is a spatial region in which the eyes of the observer (user), which is assumed to be a virtual image, are located, that is, the eyes of the user can be located in the spatial region during actual wearing. When the user's eyes are in the spatial region, the user can see the imaged picture clearly.

For example, the eyebox includes horizontal and vertical movement ranges. Taking the center of the human eye as the origin, in the horizontal direction, from the left side to the right side (or from the right side to the left side) the range in which the human eye can move (taking into account the radius of the human eye) is the horizontal eyebox; and taking the center of the human eye as the origin, in the vertical direction, from the top side to the bottom side (or from the bottom side to the top side) the range in which the human eye can move (taking into account the radius of the human eye) is the vertical eyebox.

According to the embodiments of the present disclosure, by controlling the ratio of the eyebox EB in the optical module to the distance A1 from the human eye to the polarizing element 3, it is possible to realize that within the spatial region defined by the eyebox, the viewed picture is clear and complete when the user uses the optical module for visual viewing experience, which can avoid the situation that the clarity of the picture is reduced during viewing due to the change of the position of the human eye, thereby improving the imaging quality of the optical module. Here, the position of the human eye aligns with that of the stop 4 shown in FIGS. 1 to 3.

That is to say, the optical module provided by the embodiments of the present disclosure will not result in the reduction of the clarity of the image viewed when the optical module is used due to the change of the relative position of the human eye and the optical module. The optical module of the embodiments of the present disclosure may effectively enhance the imaging quality, so as to enable different users to obtain an optimal visual experience during virtual experiences.

Specifically, the polarizing element 3 in provided in the lens group 2 and functions to reflect light. In the transmission process of the light, the polarizing element 3 naturally forms a demarcation effect on the light, that is, the light is reflected by the polarizing element 3, and the reflected light travels to the side proximate to the display screen 1. After the reflection by the beam splitting element 5, the light reflected by the beam splitting element 5 transmits through the polarizing element 3 to travel to the human eye side, and finally the light enters the human eye for imaging. Here, the traveling process of the light is well known to a person skilled in the art.

Based on the above function of the polarizing element 3, the embodiments of the present disclosure, by defining the ratio of the eyebox EB to the distance from the human eye to the polarizing element 3, simulate the correspondence between the light on both sides of the polarizing element 3 and the imaging quality. That is, by controlling the ratio of the eyebox EB to the distance A1 from the human eye to the polarizing element 3 within the range of 0.5 to 1, resulting in an improved experience effect.

It should be noted that in the embodiments of the present disclosure, those skilled in the art can flexibly adjust the ratio of the eyebox EB to the distance A1 from the human eye to the polarizing element 3 according to specific needs.

For example, the ratio of the eyebox EB to the distance A1 from the human eye to the polarizing element 3 may be 0.6 to 0.9.

For another example, the ratio of the eyebox EB to the distance A1 from the human eye to the polarizing element 3 may be 0.7 to 0.8.

Specifically, the closer the eyebox EB is to the distance A1 from the human eye to the polarizing element 3, the better the user's experience is.

Within the range of the above ratios, it is possible to achieve a clear and complete picture in the human eye when the eye is in different eyeboxes (the spatial region where the eye is located) for virtual experiences, thereby effectively improving the visual perception of the user.

In one embodiment, the optical module satisfies: 15 mm<F<35 mm, wherein F is an effective focal length of the optical module.

In the present embodiment, the effective focal length of the optical module is limited, wherein the effective focal length of the optical module shows the corresponding relationship between the size of the display screen 1 and the FOV, wherein the larger the display screen 1 is, the larger the effective focal length of the optical module is if the FOV is fixed, and the larger the corresponding eyebox EB is.

Therefore, the present embodiment limits the effective focal length of the optical module, so that the optical module may be adapted to the display screens 1 of different sizes. For example, it may be adapted to a small-sized display screen 1 (for example, 25 mm), a medium-sized display screen 1 (for example, 38 mm), or a large-sized display screen 1 (for example, 60 mm) and so on.

Here, the eyebox with a short focal length F is smaller than the eyebox with a long focal length F, so that the effective focal length of the optical module is adapted to the eyebox, and the human eye can obtain an imaged picture with uniform clarity in the eyebox.

In one embodiment the polarizing element 3 has an effective diameter B1 of 44 mm to 63 mm.

Specifically, the present embodiment limits the effective diameter of the polarizing element 3, such that the matching of the effective diameter of the polarizing element and the distance from the human eye to the polarizing element 3 limits the size of the overall architecture of the optical module and makes the size of the overall architecture of the optical module more reasonable, resulting in the optical module better meeting the requirements of small size, light weight and better wearing comfort.

The present embodiment limits the effective diameter of the polarizing element 3, as well as the distance from the human eye to the polarizing element 3. By controlling the ratio of the distance from the human eye to the polarizing element 3 to the effective diameter of the bearing member, the ratio is limited to range from 0.25 to 0.45, such that the size of the overall architecture of the optical module is more reasonable, resulting in the optical module better meeting the requirements of small size, light weight and better wearing comfort;
alternatively, by controlling the ratio of the effective diameter of the polarizing element 3 to the distance from the human eye to the polarizing element 3, the ratio is limited to range from 1.17 to 1.85, which simulates the traveling of light between the polarizing element 3 and the human eye and ensures the clarity and integrity of the imaging quality in the eyebox.

In one embodiment, the optical module has an effective focal length F, wherein a ratio of the eyebox EB to the effective focal length F of the optical module is from 0.4 to 0.6

In the present embodiment, the effective focal length F of the optical module determines the correspondence between the size of the display screen 1 and the FOV (matching relationship). For example, a larger size of the display screen 1 can be matched with a larger FOV. Additionally, the effective focal length F of the optical module determines the total optical length of the optical module. By comprehensively considering the correspondence between the effective focal length F of the optical module, the size of the display screen 1, the FOV, and the total optical length of the optical module, it is ensured that the eyebox is in an appropriate range.

In the present embodiment, the ratio of the eyebox to the effective focal length of the optical module is limited. By limiting the ratio to this range, it is possible to realize that in the eyebox, when the user uses the optical module for visual viewing experience, the viewed picture is clear and complete, thereby improving the imaging quality of the optical module.

In one embodiment, the optical module satisfies: 80°≤FOV≤120°.

In the present embodiment, the FOV of the optical module is limited, and the optical module is applied to the headset, which has a larger FOV. Therefore, the headset provided by the present embodiment increases the FOV, can be adapted to the display screen 1 of different sizes (especially the small-sized display screen 1), and in the eyebox, does not degrade the clarity of the imaged picture.

In the present embodiment, the FOV of the optical module is limited, and the FOV of the optical module corresponds to the effective diameter of the lens in lens group 2, which makes the optical module characterized by a small head and a large field of view. For example, the FOV of the optical module is 100°.

In one embodiment, the lens group 2 includes one lens, and the polarizing element 3 is provided on the side of the lens facing towards the human eye; or, the lens group 2 comprises at least two lenses, and the polarizing element 3 is provided between two adjacent lenses.

In one embodiment, referring to FIGS. 1 to 4, the beam splitting element 5 is provided between the display screen 1 and the lens group 2.

In the present embodiment, the setting position of the beam splitting element 5 is limited. Here, the beam splitting element 5 is provided on the side of the lens group 2 facing towards the display screen 1.

In a specific embodiment, the lens group 2 includes the lens closest to the display screen, and the lens has a surface facing towards the display screen on which the beam splitting element 5 is provided. For example, the beam splitting element 5 is attached to the surface.

In another specific embodiment, the beam splitting element 5 is provided between the lens group 2 and the display screen 1. For example, a bearing member for bearing the beam splitting element 5 is provided between the lens group 2 and the display screen 1, and the beam splitting element 5 is provided on the bearing member.

It should be noted that those skilled in the art can reasonably adjust the setting position of the beam splitting element 5 as required.

In one embodiment, referring to FIGS. 1 to 4, the polarizing element 3 is provided on the side of the lens group 2 facing away from the display screen 1; or
the lens group 2 includes at least two lenses, and the polarizing element 3 is provided between two adjacent lenses.

In the present embodiment, referring to FIG. 1, the lens group 2 includes one lens, wherein one of the lenses is a first lens 21, and the polarizing element 3 may be provided on the surface of the first lens 21 facing away from the display screen 1. Alternatively, the polarizing element 3 may be provided on the side of the first lens 21 facing away from the display screen 1, but not on the surface of the first lens 21. For example, the bearing member is provided between the first lens 21 and the human eye, and the polarizing element is provided on the bearing member.

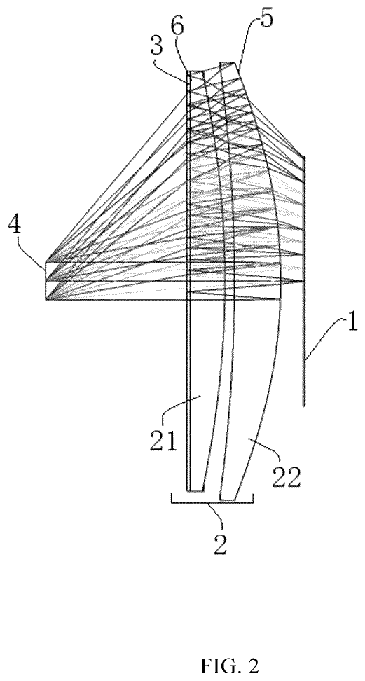

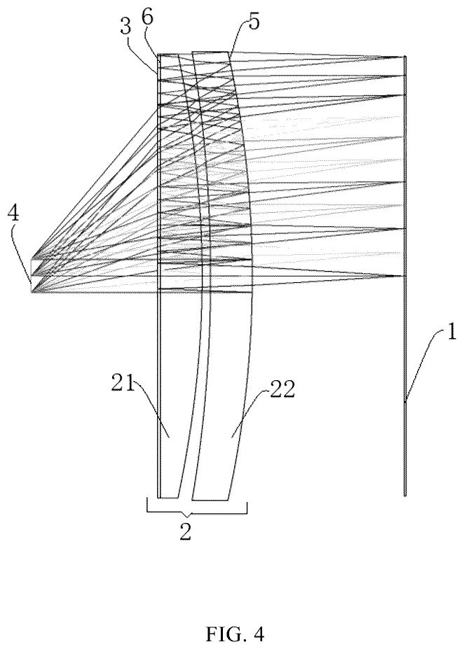

Referring to FIGS. 2 and 4, the lens group 2 includes two lenses including a first lens 21 and a second lens 22, wherein the first lens 21 is provided farther away from the display screen 1 than the second lens 22. The polarizing element 3 is provided on the surface of the first lens 21 facing away from the second lens 22.

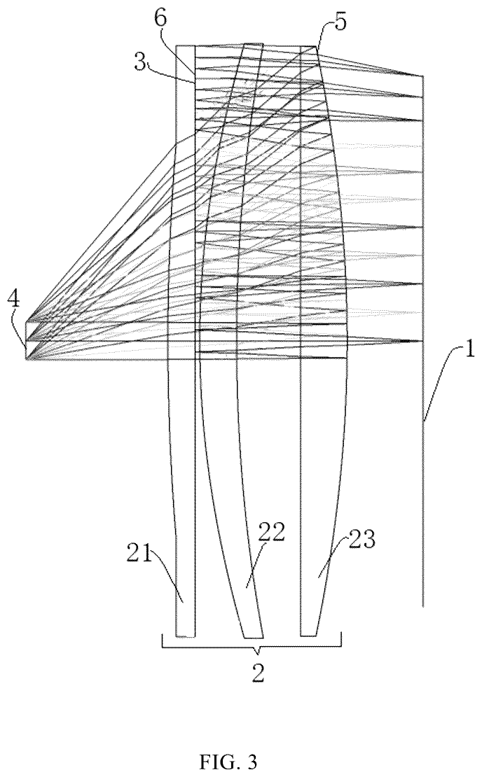

Referring to FIG. 3, the lens group 2 includes three lenses, which include a first lens 21, a second lens 22, and a third lens 23. Here, the first lens 21 is provided farther away from the display screen 1 than the third lens 23. The second lens 22 is located between the first lens 21 and the third lens 23. Here, the polarizing element 3 is provided on the surface of the first lens 21 adjacent to the second lens 22. Alternatively, the polarizing element 3 is provided between the first lens 21 and the second lens 22 but not provided on a surface of any lens, and a bearing member is provided between the first lens 21 and the second lens 22. The polarizing element 3 is provided on the bearing member.

It should be noted that those skilled in the art can reasonably adjust the setting position of polarizing element 3 as required.

In one embodiment, the phase retarder includes a first phase retarder 6 provided between the polarizing element and a lens in the lens group, or

The lens group includes at least two lenses, and the first phase retarder 6 is provided between two adjacent lenses.

In the present embodiment, referring to FIGS. 1, 2 and 4, the first phase retarder 6 is provided on the side of the lens group facing away from the display screen 1, the polarizing element 3 is provided on the side of the lens group 2 facing away from the display screen 1, and the first phase retarder 6 is located between the polarizing element and the lens group. That is, the first phase retarder 6 is located between the first lens 21 and the polarizing element 3. That is, the first phase retarder 6 is provided closer to the display screen 1 than the polarizing element 3.

Alternatively, the lens group 2 includes two lenses including a first lens 21 and a second lens 22, wherein the first lens 21 is provided farther away from the display screen 1 than the second lens 22. The first phase retarder 6 is provided between the first lens 21 and the second lens 22. For example, the first phase retarder 6 is provided on a surface of the second lens 22 adjacent to the first lens 21; or, the first phase retarder 6 is provided on a surface of the first lens 21 adjacent to the second lens 22; or, the first phase retarder 6 is provided at an appropriate position between the first lens 21 and the second lens 22.

It should be noted that those skilled in the art can reasonably adjust the setting position of the first phase retarder 6 as required.

In one embodiment, the phase retarder further includes a second phase retarder located between the lens group and the display screen.

In the present embodiment, the setting position of the second phase retarder is defined, wherein the second phase retarder is located on the side of the light emitting surface of the display screen, for example, between the lens group and the display screen.

In the present embodiment, the lens group includes a lens provided adjacent to the display screen, and the focal power of the lens is positive.

In the present embodiment, the lens group includes a lens provided adjacent to the display screen, and when the focal power of the lens is positive, the lens is a magnifying lens and magnifies the light emitted from the display screen.

For example, referring to FIGS. 1 to 4, a lens provided adjacent to the display screen includes a first surface provided facing away from the display screen and a second surface provided facing towards the display screen, the first surface being flat or concave and the second surface being convex.

In one embodiment, the eyebox EB is 8 mm to 12 mm. In one embodiment, the distance A1 from the human eye to the polarizing element 3 is greater than 13 mm.

In the present embodiment, the eyebox EB as well as the distance A1 from the human eye to the polarizing element 3 are limited, and thus it is possible to control the ratio of the eyebox to the distance from the human eye to the polarizing element 3 to meet the requirement on the ratio range of 0.5 to 1, so that when the user uses the optical module during the movement of the eye to the eyebox, there will be no decrease in clarity.

In one embodiment, the distance A1 from the human eye to the polarizing element 3 is greater than 13 mm.

The present embodiment limits the distance from the human eye to the polarizing element 3, wherein, when the distance from the human eye to the polarizing element 3 is shorter, according to the design requirements of the optical module (in order to avoid a stubby optical architecture, the width and length of the optical module are generally required to be within an appropriate range), the overall effective diameter of the optical module becomes smaller, so as to obtain a more compact optical module. However, when the distance from the human eye to the polarizing element 3 is shorter, the ratio relationship of the eyebox to the distance from the human eye to the polarizing element 3 is not satisfied, and therefore, by defining the ratio relationship of the eyebox to the distance from the human eye to the polarizing element 3, the eyebox EB, and the distance from the human eye to the polarizing element 3, the structure of the optical module is more compact and lighter under the condition of meeting the requirement on clarity.

In an optional embodiment, the distance A1 from the human eye to the polarizing element 3 is 13 mm to 15 mm.

In one embodiment, the optical module further includes the display screen 1, which has a size of D1. The polarizing element 3 has an effective diameter B1. A distance from the polarizing element 3 to the display screen 1 is L1; wherein the optical module satisfies: −0.2<B1/2−D1/2/L1<0.8.

In the present embodiment, (B1/2−D1/2)/L1 is limited, and by combining it with the ratio relationship of the eyebox to the distance from the human eye to the polarizing element 3, it is possible to ensure the clarity and the uniformity of the brightness of the imaged picture within the eyebox.

Specifically, in the present embodiment, the size of the display screen 1 is D1, wherein the size of the display screen 1 is the maximum size of a screen for displaying an image picture. For example, the display screen 1 has an area for displaying a picture, which is the largest size.

In the present embodiment, the effective diameter of polarizing element 3 is B1. In the present embodiment, the distance from the polarizing element 3 to the display screen 1 is defined as L1 no matter where the polarizing element 3 is provided.

In the present embodiment, (B1/2−D1/2)/L1 is limited to be within this range, and the uniformity of the brightness of the displayed image is adjusted (the smaller the difference is, the higher the uniformity is, and the larger the difference is, the lower the uniformity is), so that when the user observes images at different viewing angles, the difference in the brightness of the images at different viewing angles is small, that is, the difference in the brightness visually perceived when the user observes the image of the center region and the image of the edge region is small, and thus the user's eyes are not easily tired when observing the screen, thereby improving the user's experience.

Specifically, wherein, the polarizing element 3 is the most critical and effective film layer for reflecting light in the folded optical path, and the propagating direction of the light reflected by the polarizing element 3 in the image edge area of the display screen 1 can basically correspond to the propagating direction of the light in the marginal field of view of the light source module. Specifically, the tangent value of the angle of the edge light is approximately the ratio of the difference between the effective diameter B1 of the polarizing reflection film 3 and the size D1 of the display screen 1 to the distance L1 from the polarizing reflection film 3 to the display screen 1.

Therefore, in order to better simulate the incident angle of the light emitted by the image in the display screen 1 (because the incident angle cannot be accurately controlled), the present embodiment limits the relationship of the effective diameter B1 of the polarizing element 3, the distance L1 from the polarizing element 3 to the display screen 1, and the size D1 of the display screen 1, such that (B1/2−D1/2)/L1 can substantially reflect the brightness relationship between the brightness of the light in the marginal field of view and the brightness of the light in the central field of view.

Specifically, (B1/2−D1/2)/L1 is within this range, so that the polarizing element 3 and the display screen 1 have a good matching effect, and the effective diameter provided with the polarizing element 3 and the display screen 11 have a good matching effect. Specifically, (B1/2−D1/2)/L1 mainly adjusts the brightness of the marginal field of view, so that the decrease range of the brightness of the marginal field of view relative to the brightness of the central field of view is controlled within 30%, thereby meeting the sensitivity of the human eye to observe the image brightness.

Therefore, the present embodiment limits the (B1/2−D1/2)/L1, and by combining it with the ratio relationship of the eyebox to the distance from the human eye to the polarizing element 3, it is possible to ensure the clarity and the uniformity of the brightness of the imaged picture within the eyebox.

In one embodiment, a distance from the polarizing element 3 to a display screen 1 satisfies: 11 mm<L1<30 mm.

In the present embodiment, in the optical module, wherever the polarizing element 3 is provided in the optical module, it is necessary for the distance from the polarizing element 3 to the display screen 1 to be within this range. The present embodiment controls the distance from the polarizing element 3 to the display screen 1, which, on one hand, makes the range of (B1/2−D1/2)/L1 within the range of −0.2 to 0.8, and reduces the difference between the light brightness of the marginal field of view and the light brightness of the central field of view; on the other hand, by combining the distance A1 from the human eye to the polarizing element 3 and limiting the distance from the polarizing element 3 to the display screen 1, the total optical length of the optical module is limited within a certain range, such that optical module meet the requirements on miniaturization and light weight.

According to a second aspect of an embodiment of the present disclosure, a head mounted display is provided. The head mounted display includes: a housing; and the optical module as described above.

The head mounted display is, for example, a VR headset, including VR glasses or a VR helmet, which is not specifically limited in the embodiment of the present disclosure.

The specific implementation of the head mounted display in the embodiment of the present disclosure may refer to the above embodiments of the display module, and is not repeated herein.

The optical module provided by the embodiment of the present disclosure is specifically described below through four embodiments.

### First Embodiment

Referring to FIG. 1, the optical module provided by the embodiment of the present disclosure includes a display screen 1, a first lens 21 and a stop 4, wherein the first lens 21 has a second surface facing towards the display screen 1 and a first surface facing away from the display screen 1, a beam splitting element 5 is provided on the second surface, and a polarizing element 3 and a first phase retarder 6 are provided on the first surface. Here, the first phase retard 6 is provided closer to the first lens 21 with respect to the polarizing element 3. Here, the setting position of stop 4 is the position of human eyes.

Here, the distance A1 from the human eye to the polarizing element 3 is 15 mm, and the eyebox EB is 12 mm (where the horizontal eyebox and the vertical eyebox may be equal or unequal). The effective focal length F of the optical module is 28.79 mm and the effective diameter B1 of the polarizing element 3 is 44.34 mm (since the polarizing element 3 is provided on the surface of the first lens 21, the effective diameter of the first lens 21 herein is 44.34 mm), the size D1 of the display screen 1 is 46 mm, and the distance L1 from the polarizing element 3 to the display module is 27.0916 mm.

Here, the optical parameters of the display screen 1, the first lens 21, and the stop 4 are shown in Table 1.

| | | Curvature | | | |
|---|---|---|---|---|---|
| | | radius | Thickness | Refractive | Diameter |
| Type | Part | (mm) | (mm) | index (Nd) | (mm) |
| stop | Stop | Infinity | 15 | | 4 |
| first lens | P1S1 | Infinity | 4.9943 | 1.5447 | 44.34 |
| | P1S2 | −101.582 | 22.0973 | 1.5447 | 44.34 |
| display | Display | Infinity | | | 46 |
| screen | | | | | |

The present embodiment is adapted to the size of an image surface of FOV of 100° and 46 mm (medium size screen). In the present embodiment, EB/A1=0.8, and then the human eyes are controlled within the eyebox and can visually observe clear images.

In the present embodiment, EB/F=0.417, and then the human eyes are controlled within the eyebox and can visually observe clear images.

In the present embodiment, EB/A1=0.8 and EB/F=0.417, and then the human eyes are controlled within the eyebox and can visually observe clear images.

The present embodiment is adapted to the size of an image surface of FOV of 100° and 46 mm. In the present embodiment, (B1/2−D1/2)/L1=−0.031, and then the display brightness of the marginal field of view is controlled to decrease by no more than 10% compared to the brightness at a 0° angle (central field of view). That is, the brightness of light in the marginal field of view has been reduced, thereby enhancing the uniformity of brightness of the display screen 1.

### Second Embodiment

Referring to FIG. 2, the optical module provided by the embodiment of the present disclosure includes a display screen 1, a first lens 21, a second lens 22, and a stop 4. Here, the first lens 21 is provided farther away from the display screen 1 than the second lens 22, the first lens 21 has a first surface facing away from the display screen 1, and a second surface provided adjacent to the second lens 22, the second lens 22 has a first surface provided adjacent to the first lens 21 and a second surface facing towards the display screen 1. For example, a polarizing element 3 and a first phase retarder 6 are provided on the first surface of the first lens 21. Here, the first phase retarder 6 is provided closer to the first lens 21 than polarizing element 3, and the beam splitting element 5 is provided on the second surface of the second lens 22.

Here, the distance A1 from the human eye to the polarizing element 3 is 15 mm, and the eyebox EB is 9 mm (where the horizontal eyebox and the vertical eyebox may be equal or unequal). The effective focal length F of the optical module is 15.7 mm, the effective diameter B1 of the polarizing element 3 is 44.5 mm (since the polarizing element 3 is provided on the surface of the first lens 21, the effective diameter of the first lens 21 herein is 44.5 mm), the effective diameter B1 of the first lens 21 is 44.5 mm, the size D1 of the display screen 1 is 26 mm, and the distance L1 from the polarizing element 3 to the display module is 12 mm.

Here, the optical parameters of the display screen 1, the first lens 21, the second lens 22, and the stop 4 are shown in Table 2.

| | | Curvature | | | |
|---|---|---|---|---|---|
| | | radius | Thickness | Refractive | Diameter |
| Type | Part | (mm) | (mm) | index (Nd) | (mm) |
| stop | Stop | Infinity | 15 | | 4 |
| first lens | P1S1 | Infinity | 3.704 | 1.5447 | 44.5 |
| | P1S2 | −100.191 | 0.9944 | 1.5447 | 44.5 |
| second lens | P2S1 | −175.123 | 4.9104 | 1.5447 | 46.34 |
| | P2S2 | −53.86 | 2.3821 | 1.5447 | 46.34 |
| display | Display | Infinity | | | 26 |
| screen | | | | | |

The present embodiment is adapted to the size of an image surface of FOV of 100° and 26 mm (small size screen). In the present embodiment, EB/A1=0.6, and then the human eyes are controlled within the eyebox and can visually observe clear images.

In the present embodiment, EB/F=0.573, and then the human eyes are controlled within the eyebox and can visually observe clear images.

In the present embodiment, EB/A1=0.6 and EB/F=0.573, and then the human eyes are controlled within the eyebox and can visually observe clear images.

The present embodiment is adapted to the size of an image surface of FOV of 100° and 26 mm. In the present embodiment, (B1/2−D1/2)/L1=0.77, and then the display brightness of the marginal field of view is controlled to decrease by no more than 30% compared to the brightness at a 0° angle (central field of view). That is, the brightness of light in the marginal field of view has been reduced, thereby enhancing the uniformity of brightness of the display screen 1.

### Third Embodiment

Referring to FIG. 3, the optical module provided by the embodiment of the present disclosure includes a display screen 1, a first lens 21, a second lens 22, and a third lens 23. Here, the first lens 21 is provided farther away from the display screen 1 than the third lens 23, the third lens 23 is provided adjacent to the display screen 1, and the second lens 22 is located between the first lens 21 and the third lens 23.

The first lens 21 has a first surface facing away from the second lens 22 and a second surface provided adjacent to the second lens 22; the second lens 22 has a first surface provided adjacent to the first lens 21 and a second surface provided adjacent to the third lens 23; the third lens 23 has a first surface provided adjacent to the second lens 22 and a second surface provided facing towards the display screen 1.

For example, a polarizing element 3 and a first phase retarder 6 are provided on the second surface of the first lens 21. Here, the first phase retarder 6 is provided closer to the second lens 21 than the polarizing element 3 (i.e., the first phase retarder 6 is provided closer to the display than the polarizing element 3), and a beam splitting element 5 is provided on the second surface of the third lens 23.

Here, the distance A1 from the human eye to the polarizing element 3 is 15 mm, the eyebox EB is 12 mm, and the effective focal length of the optical module is F=34.7 mm; the effective diameter B1 of polarizing element 3 is 62.55 mm (since the polarizing element 3 is provided on the surface of the first lens 21, the effective diameter of the first lens 21 herein is 62.55 mm), the size D1 of the display screen 1 is 56 mm, and the distance L1 from the polarizing element 3 to the display screen 1 is 24.089 mm.

Here, the optical parameters of the display screen 1, the first lens 21, the second lens 22, the third lens 23 and the stop 4 are shown in Table 3.

| | | Curvature | | | |
|---|---|---|---|---|---|
| | | radius | Thickness | Refractive | Diameter |
| Type | Part | (mm) | (mm) | index (Nd) | (mm) |
| stop | Stop | Infinity | 15 | | 4 |
| first lens | P1S1 | 250 | 2.868 | 1.534 | 62.55 |
| | P1S2 | Infinity | 0.5 | | 62.55 |
| second lens | P2S1 | 100 | 3.894 | 1.5447 | 62.92 |
| | P2S2 | 180 | 6.757 | | 62.92 |
| third lens | P3S1 | Infinity | 4.938 | 1.5447 | 62.44 |
| | P3S2 | −142.42 | 8 | | 62.44 |
| display | Display | Infinity | | | 56 |
| screen | | | | | |

The present embodiment is adapted to the size of an image surface of FOV of 100° and 56 mm (large size screen). In the present embodiment, EB/A1=0.8, and then the human eyes are controlled within the eyebox and can visually observe clear images.

In the present embodiment, EB/F=0.346, and then the human eyes are controlled within the eyebox and can visually observe clear images.

In the present embodiment, EB/A1=0.8 and EB/F=0.346, and then the human eyes are controlled within the eyebox and can visually observe clear images.

The present embodiment is adapted to the size of an image surface of FOV of 100° and 56 mm (large size screen). In the present embodiment, (B1/2−D1/2)/L1=0.136, and then the display brightness of the marginal field of view is controlled to decrease by no more than 15% compared to the brightness at a 0° angle (central field of view). That is, the brightness of light in the marginal field of view has been reduced, thereby enhancing the uniformity of brightness of the display screen 1.

### Fourth Embodiment

Referring to FIG. 4, the optical module provided by the embodiment of the present disclosure includes a display screen 1, a first lens 21, a second lens 22, and a stop 4. Here, the first lens 21 is provided farther away from the display screen 1 than the second lens 22, the first lens 21 has a first surface facing away from the display screen 1, and a second surface provided adjacent to the second lens 22, the second lens 22 has a first surface provided adjacent to the first lens 21 and a second surface provided facing towards the display screen 1. For example, a polarizing element 3 and a first phase retarder 6 are provided on the first surface of the first lens 21. Here, the first phase retarder 6 is provided closer to the first lens 21 than the polarizing element 3, and the beam splitting element 5 is provided on the second surface of the second lens 22.

Here, the distance A1 from the human eye to the polarizing element 3 is 15 mm, and the eyebox EB is 12 mm (where the horizontal eyebox and the vertical eyebox may be equal or unequal). The effective focal length F of the optical module is 35.52 mm and the effective diameter B1 of the polarizing element 3 is 52.7 mm (since the polarizing element 3 is provided on the surface of the first lens 21, the effective diameter of the first lens 21 herein is 52.7 mm), the size D1 of the display screen 1 is 52 mm, and the distance L1 from the polarizing element 3 to the display module is 28.91 mm.

Here, the optical parameters of the display screen 1, the first lens 21, the second lens 22, and the stop 4 are shown in Table 4.

| | | Curvature | | | |
|---|---|---|---|---|---|
| | | radius | Thickness | Refractive | Diameter |
| Type | Part | (mm) | (mm) | index (Nd) | (mm) |
| stop | Stop | Infinity | 15 | | 4 |
| first lens | P1S1 | Infinity | 4.97 | 1.5447 | 52.7 |
| | P1S2 | −116.5 | 1 | 1.5447 | 52.7 |
| second lens | P2S1 | −166.5 | 4.94 | 1.5447 | 53.3 |
| | P2S2 | −125.02 | 18 | 1.5447 | 53.3 |
| display | Display | Infinity | | | 52 |
| screen | | | | | |

The present embodiment is adapted to the size of an image surface of FOV of 100° and 52 mm (large size screen). In the present embodiment, EB/A1=0.8, and then the human eyes are controlled within the eyebox and can visually observe clear images.

In the present embodiment, EB/F=0.338, and then the human eyes are controlled within the eyebox and can visually observe clear images.

In the present embodiment, EB/A1=0.8 and EB/F=0.338, and then the human eyes are controlled within the eyebox and can visually observe clear images.

The present embodiment is adapted to the size of an image surface of FOV of 100° and 56 mm. In the present embodiment, (B1/2−D1/2)/L1=0.012, and then the display brightness of the marginal field of view is controlled to decrease by no more than 10% compared to the brightness at a 0° angle (central field of view). That is, the brightness of light in the marginal field of view has been reduced, thereby enhancing the uniformity of brightness of the display screen 1.

According to another aspect of an embodiment of the present disclosure, there is also provided a head mounted display including a housing and the optical module as described above.

The above embodiments focus on the differences between the various embodiments, and the different optimization features between the various embodiments, as long as they do not contradict each other, may be combined to form a better embodiment, which will not be repeated herein considering the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. An optical module adapted for viewing by a human eye, comprising:
a lens group comprising at least one lens;
a polarizing element,
a beam splitting element, and
a phase retarder,
wherein the polarizing element, the beam splitting element, and the phase retarder are provided on at least a first side of the lens group,
a distance from the human eye to the polarizing element is A1,
and wherein an eyebox (EB) of the human eye
satisfies: 0.5≤(EB/A1)≤1.

2. The optical module according to claim 1, wherein the optical module has an effective focal length F, which satisfies: 15 mm<F<35 mm.

3. The optical module according to claim 1, wherein the polarizing element has an effective diameter B1 from 44 mm to 63 mm.

4. The optical module according to claim 1, wherein the optical module has an effective focal length F, which satisfies 0.4−≤(EB/F)≤0.6.

5. The optical module according to claim 1, wherein the optical module has a Field of View (FOV) from 80° to 120°.

6. The optical module according to claim 1, further comprising a display screen positioned proximate to the lens group, and wherein the beam splitting element is provided on a side of the lens facing away from the human eye.

7. The optical module according to claim 1, wherein the lens group has a near-eye side, with the polarizing element is provided thereon; or
the lens group comprises at least two lenses, with the polarizing element provided therebetween.

8. The optical module according to claim 1, wherein the phase retarder comprises a first phase retarder between the beam splitting element and the polarizing element.

9. The optical module according to claim 1, further comprising a display screen positioned proximate to the lens group, wherein the phase retarder comprises a second phase retarder;
and the second phase retarder is provided on one side of the lens group facing away from the human eye.

10. The optical module according to claim 1, further comprising a display screen positioned adjacent to a first lens of the at least one lens in the lens group, wherein the first lens has a positive focal power.

11. The optical module according to claim 1, wherein the EB is from 8 mm to 12 mm.

12. The optical module according to claim 1, wherein A1 is greater than 13 mm.

13. The optical module according to claim 1, further comprising a display screen with a size of D1;
the polarizing element has an effective diameter B1;
a distance from the polarizing element to the display screen is L1, which satisfies: −0.2<(B1/2−D1/2)/L1<0.8.

14. The optical module according to claim 1, further comprising a display screen, wherein a distance from the polarizing element to a display screen is L1, which satisfies: 11 mm<L1<30 mm.

15. A head mounted display, comprising:
a housing; and
an optical module according to claim 1.
